(19) United States
(12) Patent Application Publication
(10) Pub. No.: US 2008/0289240 A1
(43) Pub. Date: Nov. 27, 2008

(54) Illuminated fishing lure

(76) Inventor: James Cheung, Warren, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/584,692

(22) Filed: Oct. 20, 2006

(51) Int. Cl. A01K 85/01

(52) U.S. Cl. 43/17.6

(57) ABSTRACT

A fishing lure is disclosed. The fishing lure includes a hook having a shank and a light source located in the shank. The fishing lure further includes a motion sensor for activating the light source when motion is sensed and a water sensor for activating the motion sensor when water is sensed. The fishing lure further includes a bait element coupled with the shank such that when the light source is activated, the bait element is illuminated

### FIELD OF THE INVENTION

The invention disclosed broadly relates to the field of sport fishing, and more particularly relates to the field of fishing lures for sport fishing.

### BACKGROUND OF THE INVENTION

In terms of sport fishing, a fishing lure is an object designed to resemble fish prey, such as spinner bait or trout worms, and equipped with one or many hooks that is used to catch fish. The fishing lure is attached to the end of a fishing line and is then thrown out into the water and pulled back to attract fish. The fishing lure may float on the water surface, slowly sink or float underwater, based on real behavior of the fish prey being resembled.

Many different types of fishing lures exist. A common type of lure includes a hook in combination with fake or genuine bait. The bait prompts a fish to bite the fishing lure, which snags the fish, typically in the mouth area, with the hook. One feature that has been added to this type of fishing lure is a light. Because fish are attracted to light, the combination of bait with a light is desirable. Yet another feature that has been added to this type of fishing lure is a motion sensor so that the light is activated only when motion is sensed, so as to preserve the battery of the electrical system powering the light source. This approach, however, fails to preserve battery power when the fishing lure is not in the water. Thus, although battery power is preserved when the fishing lure is not moving, the light source will be activated when the fishing lure is moved while in the fisherman's tackle box or during transportation. This is disadvantageous as it is only desirable to have the fishing lure illuminated while being used in the water.

Therefore, a need exists to overcome the problems with the prior art as discussed above, and particularly for a more efficient way to preserve battery power in an illuminated fishing lure.

### SUMMARY OF THE INVENTION

Briefly, according to an embodiment of the present invention, a fishing lure is disclosed. The fishing lure includes a hook having a shank and a light source located in the shank. The fishing lure further includes a motion sensor for activating the light source when motion is sensed and a water sensor for activating the motion sensor when water is sensed. The fishing lure further includes a bait element coupled with the shank such that when the light source is activated, the bait element is illuminated.

In another embodiment of the present invention, a fishing lure is disclosed. The fishing lure includes a hook and a housing integrally formed with the hook, the housing comprising a light source, a motion sensor for activating the light source when motion is sensed and a water sensor for activating the motion sensor when water is sensed. The fishing lure further includes a bait element coupled with the housing such that when the light source is activated, the bait element is illuminated.

In another embodiment of the present invention, method for illuminated a fishing lure is disclosed. The method includes activating, by a water sensor, a motion sensor when water is sensed and activating, by the motion sensor, a light source when motion is sensed. The method further includes illuminating, by the light source, a translucent housing holding the water sensor, the motion sensor and the light source when activated by the motion sensor. The method further includes illuminating a bait element coupled with the housing and a hook, when the housing is illuminated.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the main components of an illuminated fishing lure, according to one embodiment of the present invention.

FIG. 2 is an illustration of a frontal view of an illuminated fishing lure, according to one embodiment of the present invention.

FIG. 3 is an illustration of a frontal view of an illuminated fishing lure, according to another embodiment of the present invention.

FIG. 4 is an illustration of a side view of a motion sensor for use with an illuminated fishing lure, according to another embodiment of the present invention.

FIG. 5 is an illustration of a side view of another motion sensor for use with an illuminated fishing lure, according to another embodiment of the present invention.

FIG. 6 is an illustration of a frontal view of an illuminated fishing lure, according to another embodiment of the present invention.

### DETAILED DESCRIPTION

The present invention provides a simplified fishing lure that can be illuminated so as to attract fish. The fishing lure includes a light source located in the shank of a hook. The fishing lure further includes a motion sensor for activating the light source when motion is sensed and a water sensor for activating the motion sensor when water is sensed. This preserves the power supply of the fishing lure so as to expend battery power only when the fishing lure is moving while immersed in water. The fishing lure further includes a bait element coupled with the shank such that when the light source is activated, the bait element is illuminated.

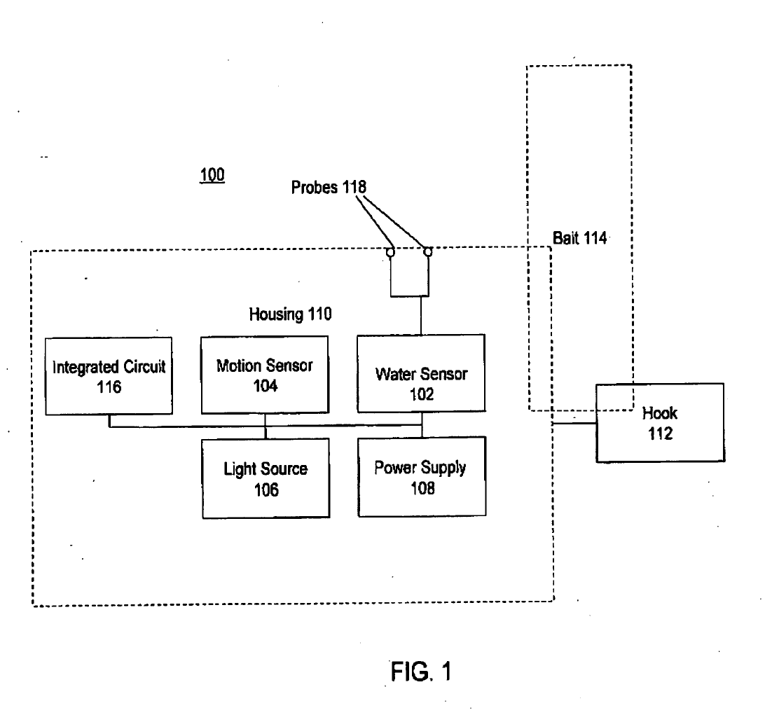

FIG. 1 is a block diagram illustrating the main components of an illuminated fishing lure 100, according to one embodiment of the present invention. FIG. 1 shows that illuminated fishing lure 100 includes a hook 112, as well as a housing 110 that is coupled with the hook 112. The hook 112, described in greater detail below, is used to snag or capture a fish. The housing 110 houses a variety of components. Namely, the housing 110 houses a motion sensor 104, a water sensor 102, a light source 106, an integrated circuit 116 and a power supply 108.

The motion sensor 104 can be an accelerometer, which is a device for measuring acceleration. An accelerometer inherently measures its own motion. In one embodiment of the present invention, the motion sensor 104 is an accelerometer used along with a gyroscope. In another embodiment of the present invention, the motion sensor 104 is a micro electro-mechanical system (MEMS) accelerometer. In this case the accelerometer is used to detect the rapid acceleration or deceleration of the illuminated fishing lure 100. MEMS accelerometers are available in a wide variety of ranges and arrangements, including single axis, dual axis, and three axis models. Other types of accelerometers include piezo-film or piezoelectric sensors, surface micromachined capacitive accelerometers, thermal accelerometers, bulk micromachined capacitive accelerometers, bulk micromachined piezo resistive, electromechanical servo accelerometers and null-balance accelerometers.

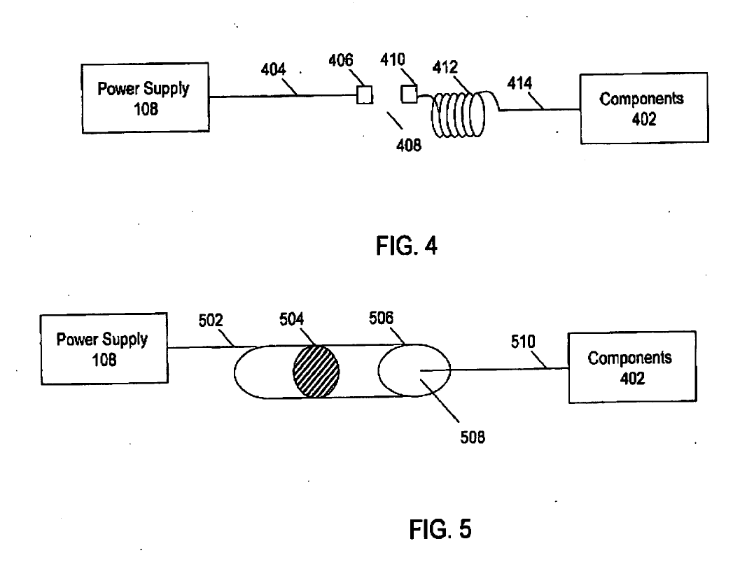

In another embodiment of the present invention, the motion sensor 104 can be a device that completes a circuit when motion is sensed, thereby activating the light source 106. This embodiment is described in greater detail below with reference to FIGS. 4 and 5.

The water sensor 102 is a sensor used to detect the presence of fresh or salt water. In one embodiment of the present invention, the water sensor 102 can be a hygroscopic disk that swells in the presence of water, wherein an electrical switch is in turn depressed or released by the hygroscopic disk stack. In another embodiment of the present invention, the water sensor 102 can be an electrical type sensor that uses tipping bucket or conductance type probes, such as probes 118, which can be located outside the housing 110. The probes 118 are electrical conductors that serve to conduct a current between them when a sufficient conductor, such as fresh or salt water, is present between them. Thus, upon immersion in water, a current is transmitted between probes 118 and the motion sensor 102 detects the presence of water.

FIG. 1 further shows integrated circuit 116, which can be a miniaturized electronic circuit (consisting mainly of semiconductor devices, as well as passive components) which has been manufactured in the surface of a thin substrate of semiconductor material. The integrated circuit 116 can be analog, digital or mixed signal (both analog and digital on the same chip).

In one embodiment of the present invention, the integrated circuit 116 controls various functions of the fishing lure 100, such as the management of the water sensor 102, the motion sensor 104 and the light source 106. For example, the integrated circuit 116 may receive a signal from the water sensor 102 indicating the presence of water, thereby prompting the integrated circuit 116 to activate the motion sensor 104. If the integrated circuit 116 subsequently receives a signal from the motion sensor 104 indicating the existence of motion, the integrated circuit 116 may then activate the light source 106 for a predetermined period of time. The integrated circuit 116 may instruct the light source 106 to illuminate in a variety of ways, such as by flashing rapidly or slowly, flashing in a repeated or random pattern or simply remaining illuminated continuously.

In one embodiment of the present invention, the present invention includes a timer for use when activating the light source 106. Upon activation of the light source by the integrated circuit 116 or any other element, the timer may be used to determine the amount of time the light source 106 is activated. For example, the timer may be used to time or limit the amount of time the light source 106 is illuminated.

In another embodiment of the present invention, the present invention includes a means for adjusting the manner in which the light source 106 illuminates. As explained above, the light source 106 may illuminate in a variety of ways, such as by flashing rapidly or slowly, flashing in a repeated or random pattern or simply remaining illuminated continuously. In this embodiment, a device, such as a rheostat, may be used to modify the pattern in which the light source 106 illuminates. A rheostat is variable resistor that enables the resistance to a current in an electric circuit to be increased or decreased, thereby varying the current without interrupting the current flow. As the rheostat is varied, such as by turning a knob, the pattern in which the light source 106 is illuminated may change from one pattern or setting to another.

In another embodiment of the present invention, the power supply 108 for powering the illuminated fishing lure 100 may comprise a standard commercially available alkaline battery, such as an AA size or an AAA size battery that ranges from 1.5 volts to 9 volts each. Alternatively, the power supply 108 may be any commercially available silver oxide or lithium battery providing from 1.5 to 3 volts. In another alternative, the power supply 108 may be a nickel cadmium battery, a nickel metal hydride battery, a lithium ion battery, or a zinc air battery. The housing 110 may allow for the power supply 108 for the illuminated fishing lure 100 to be inserted or removed from the housing 110 multiple times.

In another embodiment of the present invention, the power supply 108 for powering the illuminated fishing lure 100 may comprise a rechargeable and/or a replaceable battery, as specified in more detail above. In this embodiment, the battery may be replaced when depleted or may be removed and replaced after being fully recharged.

In another embodiment of the present invention, the light source 106 is one or more Light Emitting Diodes (LEDs). An LED is a semiconductor device that emits incoherent narrow-spectrum light when electrically biased in the forward direction. In another embodiment of the present invention, the light source 106 is one or more Electro-Luminescent (EL) light panels. An EL light panel is a material that emits light in response to an electric current passed through it, or to a strong electric field. In another embodiment of the present invention, the light source 106 may emanate any visible or non-visible spectrum of light.

The housing 110 can be constructed of a common semi-synthetic polymerization product such as plastic. In one embodiment, the housing 110 is constructed from a material that is translucent or transparent so as to allow light from the light source 106 to escape from the interior of the housing 110 to the exterior. In this embodiment, the housing 110 allows for the passage of light from the interior of the housing 110 to the exterior. The housing 110 may diffuse the light as it passes through the housing 110. The housing 110 may further be water resistant or water proof so as to protect the electrical components (water sensor 102, light source 106, motion sensor 104 and power supply 108) from the elements, including fresh water, salt water, humidity, snow or frost.

The bait 114 can be a genuine organism, such as a small fish, or a synthetic replica of an organism. FIG. 1 shows that the bait 114 can encompass the housing 110 and/or the hook 112 at least partially. If the bait 114 is a synthetic replica, the bait 114 can be constructed of a common semi-synthetic polymerization product such as plastic. In one embodiment, the bait 114 is constructed from a material that is translucent or transparent so as to allow light from the light source 106 to escape from the interior of the bait 114 to the exterior. In this embodiment, the bait 114 allows for the passage of light from the interior of the bait 114 to the exterior. The bait 114 may diffuse the light as it passes through the bait 114.

In another embodiment of the present invention, the bait element 114 may comprise a phosphor material. A phosphor is a substance that exhibits the phenomenon of phosphorescence (sustained glowing after exposure to light or energized particles such as electrons). The phosphor material may emanate visible and non-visible light that enhances the illumination of the fishing lure 100.

In one embodiment of the present invention, the motion sensor 104 is not activated or operating until it is activated by the water sensor 102. When the water sensor 102 senses fresh or salt water, it activates the motion sensor 104. Once the motion sensor 104 is activated, it is in operating mode and can sense motion. This process preserves the power supply 108 such that power is not expended by the light source 106 or the motion sensor 104 while the fishing lure 100 is not immersed in water.

In another embodiment of the present invention, upon sensing motion, the motion sensor 104 activates the light source 106 so as to produce light. The light source 106 can be activated to illuminate in a variety of ways, such as by flashing rapidly or slowly, flashing in a repeated or random pattern or simply remaining illuminated continuously.

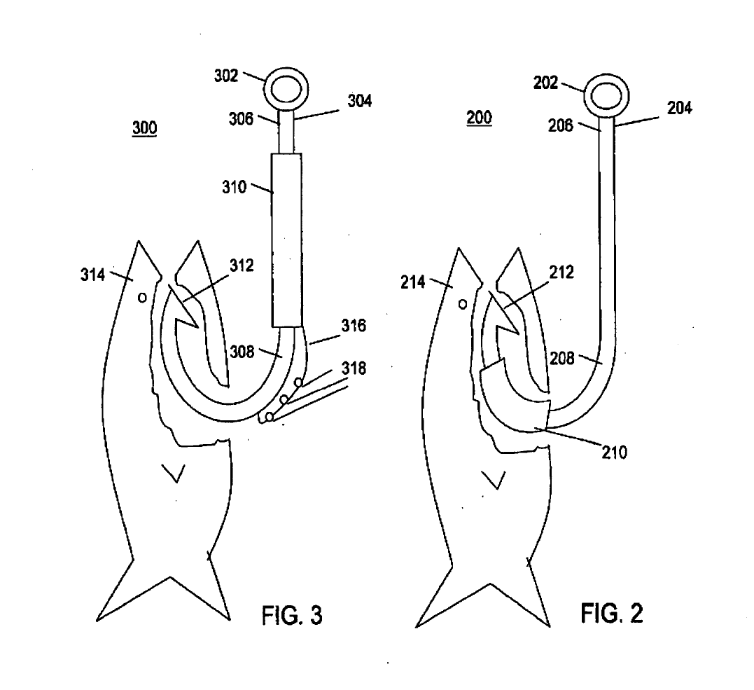

FIG. 2 is an illustration of a frontal view of an illuminated fishing lure 200, according to one embodiment of the present invention. FIG. 2 shows a conventional hook 204 comprising an eye 202 for threading a fishing line, a shank 206 comprising a cylindrical shaft, a barb 212 comprising a sharp projection extending backward and a bend 208, which defines a curve connecting the shank 206 with the barb 212. FIG. 2 shows a housing 210, corresponding to housing 110 of FIG. 1, located on a bottom portion of the bend 208 of the hook 204. The bait 214 (corresponding to bait 114 of FIG. 1 and shown in a cutout form) is hooked onto the hook 204 via the barb 212 and encompasses at least a portion of the hook 204, as well as the housing 210.

In an embodiment of the present invention, when the light source 106 within housing 210 is illuminated, the housing 210 (which is constructed from a material that is translucent or transparent) allows for the passage of light from the interior of the housing 210 to the exterior. Thus, this allows for the illumination of the interior of the bait 114. Consequently, the bait 114 (which is constructed from a material that is translucent or transparent) allows for the passage of light from the interior of the bait 114 to the exterior. Thus, this allows for the illumination of the exterior of the bait 114.

In another embodiment of the present invention, when the light source 106 within housing 210 is illuminated, the housing 210 is illuminated. Consequently, the interior of the bait 114 is illuminated by the portion of the housing 210 located within the bait 114 and the exterior of the bait 114 is illuminated by light from the portion of the housing 210 located outside of the bait 114.

FIG. 3 is an illustration of a frontal view of an illuminated fishing lure 300, according to another embodiment of the present invention. FIG. 3 shows a conventional hook 304 (similar to hook 204 of FIG. 2) comprising an eye 302 for threading a fishing line, a shank 306 comprising a cylindrical shaft, a barb 312 comprising a sharp projection extending backward and a bend 308, which defines a curve connecting the shank 306 with the barb 312. FIG. 3 shows a housing 310, corresponding to housing 110 of FIG. 1, located on the shank 306 of the hook 304. The bait 314 (corresponding to bait 114 of FIG. 1 and shown in a cutout form) is hooked onto the hook 304 via the barb 312 and encompasses at least a portion of the hook 304.

FIG. 3 further includes a curved element 308 extending from a bottom portion of the housing 310 and extending along the bend 308 of the hook 304. The curved element 308 acts like a wave guide to guide the light emanating downwards from the light source 106 within housing 310. Orifices 318 located on a bottom portion of the curved element 308 allow the light from the light source 106 to escape in the direction of the bait 314 so as to illuminate the bait 314.

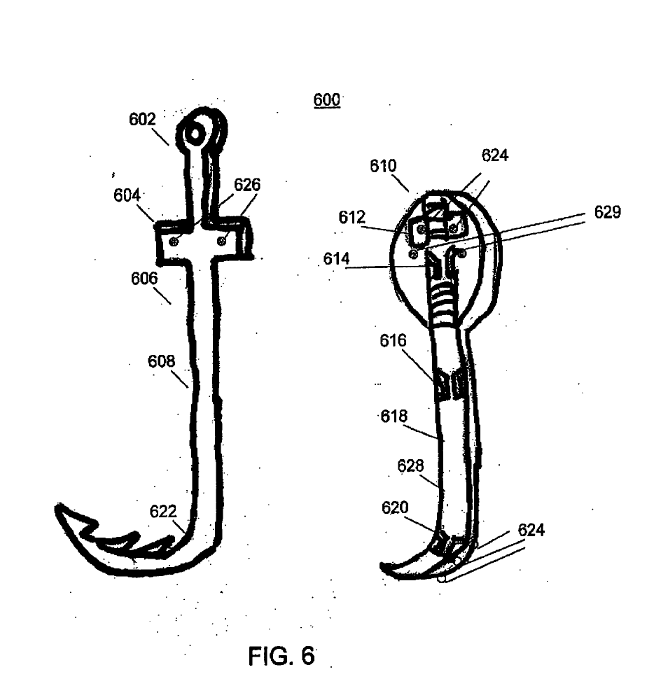

FIG. 6 is an illustration of a frontal view of an illuminated fishing lure 600, according to another embodiment of the present invention. FIG. 6 shows that the first portion of the illuminated fishing lure 600 includes a hook 602 (similar to hook 204 of FIG. 2) comprising an eye for threading a fishing line, a shank 608 comprising a cylindrical shaft, a barb comprising a sharp projection extending backward and a bend 622, which defines a curve connecting the shank 608 with the barb. Hook 602 includes a T-element 604 comprising side panels on each side of the shank 608. Drilled into each side panel of T-element 604 is an orifice 626.

FIG. 6 shows that the second portion of the illuminated fishing lure 600 includes a housing 610, corresponding to housing 110 of FIG. 1, for coupling with the hook 602. The housing 610 includes an indentation or a depression 618 that fits the shank 608 and bend 622 such that the hook 602 may fit securely within the depression 618. The housing 610 further includes an indentation or a depression 612 that fits the T-element 604 of hook 602. Also shown in FIG. 6 is a first pair of fasteners 614, including a pair of curved, adjustable planar elements, which are secured around the portion 606 of shank 608 of hook 602. Also shown are a second pair of fasteners 616, which are secured around the shank 608 of hook 602, and a third pair of fasteners 620, which are secured around the bend 622 of hook 602.

Housing 610 further includes a curved element 628 extending from a bottom portion of the housing 610, for coupling with the bend 622 of the hook 602. The curved element 628 acts like a wave guide to guide the light emanating downwards from the light source 106 within housing 610. Orifices 624 located on a bottom portion of the curved element 628 allow the light from the light source 106 to escape in the direction of the bait so as to illuminate it.

Drilled into the depression 612 in housing 610 is a pair of orifices 624, for alignment with the orifices 626 in each side panel of T-element 604. When the orifices 624 of depression 612 are aligned with the orifices 626 of hook 602, a fastener, such as a screw or a pin, can be inserted through the orifices 624, 626 so as to fasten the hook 602 to the housing 610.

In one embodiment of the present invention, the fasteners inserted through the orifices 624, 626 act as the probes 118 for water sensor 102. That is, the fasteners perform the functions of the probes 118 for water sensor 102 and are conductively connected to water sensor 102. In another embodiment of the present invention, the probes 118 for water sensor 102 are separate elements 629 located on the outside surface of housing 610. In this embodiment, the elements 629 also perform the functions of the probes 118 for water sensor 102 and are conductively connected to water sensor 102.

FIG. 4 is an illustration of a side view of a motion sensor for use with an illuminated fishing lure, according to another embodiment of the present invention. The motion sensor of FIG. 4 completes a circuit when motion is sensed, thereby activating other components 402 within the housing 110, such as the light source 106 (see FIG. 1). FIG. 4 shows the power supply 108 coupled with a conductor 404 and a terminal 406. Coupled with the other components 402 within the housing 110 is a conductor 414, to which a spring 412 is attached on one end. On another end of the spring 412 is attached a terminal 410. Conductors 404 and 414 are stationary while spring 412 and terminal 410, which is coupled to spring 412, are movable.

It is shown that as movement of the fishing lure 100 occurs along the axis of conductors 404 and 414, the spring 412 expands or contracts along the same axis, thereby moving terminal 410 along the axis of conductors 404 and 414. As such, as the terminal 410 is moved along the axis of conductors 404 and 414, the gap 408 can increase in size or close altogether. When the gap 408 closes, a circuit is closed, thereby allowing current to flow from power supply 108 to the other components 402 within the housing 110. This current can then be used to activate light source 106.

FIG. 5 is an illustration of a side view of another motion sensor for use with an illuminated fishing lure, according to another embodiment of the present invention. The motion sensor of FIG. 5 also completes a circuit when motion is sensed, thereby activating other components 402 within the housing 110, such as the light source 106 (see FIG. 1). FIG. 5 shows the power supply 108 coupled with a conductor 502, to which a conductive hollow cylinder 506 is conductively coupled on one end. The conductive hollow cylinder 506 includes within it a conductive ball 504 that rolls within the cylinder 506 when the cylinder is moved, tipped or rocked from side to side. The ball 504 is kept in conductive contract with the conductive hollow cylinder 506 at all times, regardless of the located of the ball 504 within the cylinder 506.

Coupled with the other components 402 within the housing 110 is a conductor 510. Conductors 502 and 510 are stationary while ball 504 is movable. One end 508 of the conductor 510 is located within one open end of the hollow cylinder 506. The conductor 510 is not in conductive contact with the conductive cylinder 506. Rather, the end 508 of the conductor 510 is suspended within one open end of the hollow cylinder 506, such that the conductor 510 does not touch the hollow cylinder 506. When the ball 504 is positioned at its rightmost location within the cylinder 506, the ball 504 conductively contacts end 508 of conductor 510.

It is shown that as movement of the fishing lure 100 occurs along the axis of conductors 502 and 510, the ball 504 moves or rolls along the same axis within the cylinder 506. When the ball 504 rolls all the way to the right of the cylinder 506 and contacts end 508 of conductor 510, a circuit is closed, thereby allowing current to flow from power supply 108 to the other components 402 within the housing 110. This current can then be used to activate light source 106.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A fishing lure, comprising:
a hook having a shank;
a light source located in the shank;
a motion sensor for activating the light source when motion is sensed;
a water sensor for activating the motion sensor when water is sensed; and
a bait element coupled with the shank such that when the light source is activated, the bait element is illuminated.

2. The fishing lure of claim 1, further comprising a power source for providing power to the light source, the motion sensor and the water sensor.

3. The fishing lure of claim 2, wherein the light source comprises at least one Light Emitting Diode (LED).

4. The fishing lure of claim 3, wherein the shank comprises a translucent housing that allows light from the light source to escape to an exterior of the housing.

5. The fishing lure of claim 4, wherein the motion sensor, the water sensor and the power source are located in the housing.

6. The fishing lure of claim 3, wherein the shank comprises at least one orifice that allows light from the light source to escape to an exterior of the shank.

7. The fishing lure of claim 6, wherein the at least one orifice is located in a bend of the hook.

8. The fishing lure of claim 3, wherein the motion sensor, the water sensor and the power source are located in the shank.

9. The fishing lure of claim 8, wherein the bait element comprises a translucent housing that allows light from the light source to escape to an exterior of the housing.

10. The fishing lure of claim 8, wherein the bait element comprises an organism that allows light from the light source to escape from an orifice in the organism to an exterior of the organism.

11. A fishing lure, comprising:
a hook;
a housing integrally formed with the hook, the housing comprising a light source, a motion sensor for activating the light source when motion is sensed and a water sensor for activating the motion sensor when water is sensed; and
a bait element coupled with the housing such that when the light source is activated, the bait element is illuminated.

12. The fishing lure of claim 11, further comprising a power source for providing power to the light source, the motion sensor and the water sensor.

13. The fishing lure of claim 12, wherein the light source comprises at least one Light Emitting Diode (LED).

14. The fishing lure of claim 13, wherein the housing comprises a translucent material that allows light from the light source to escape to an exterior of the housing.

15. The fishing lure of claim 13, wherein the housing comprises at least one orifice that allows light from the light source to escape to an exterior of the housing.

16. The fishing lure of claim 14, wherein the bait element comprises a translucent housing that allows light from the light source to escape to an exterior of the housing.

17. The fishing lure of claim 16, wherein the housing is located in any one of a shank of the hook, a bend of the hook or below a barb of the hook.

18. A method for illuminating a fishing lure, comprising:
activating, by a water sensor, a motion sensor when water is sensed;
activating, by the motion sensor, a light source when motion is sensed;
illuminating, by the light source, a translucent housing holding the water sensor, the motion sensor and the light source when activated by the motion sensor; and
illuminating a bait element coupled with the housing and a hook, when the housing is illuminated.

19. The method of claim 18, further comprising:
providing power to the light source, the motion sensor and the water sensor.

20. The method of claim 19, wherein the light source provides illumination using at least one Light Emitting Diode (LED).
